(19) United States
(12) Patent Application Publication
(10) Pub. No.: US 2010/0007784 A1
(43) Pub. Date: Jan. 14, 2010

(54) IMAGING APPARATUS

(75) Inventor: Kazuhiro Haneda, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/563,481

(22) Filed: Sep. 21, 2009

Related U.S. Application Data
(63) Continuation of application No. PCT/JP2008/055946, filed on Mar. 27, 2008.

(30) Foreign Application Priority Data
Mar. 30, 2007 (JP) 2007-090468

(51) Int. Cl. H04N 5/232

(52) U.S. Cl. 348/347; 348/E05.045

(57) ABSTRACT

The imaging apparatus of the present invention is provided with an image-forming lens that images light from a photographic subject; an imaging part that accumulates a pixel signal that corresponds to an optical image formed by the image-forming lens, reads the pixel signal and outputs the pixel signal as an imaging signal; a lens magnification control part that controls a magnification of the image-forming lens; a read-out region control part that controls the size of a read-out region of the pixel signal; and a frame rate control part that controls a frame rate of the imaging signal. In the imaging apparatus of the present invention, the magnification of the image-forming lens, the size of the read-out region, and the frame rate are controlled so that an angle of view of an image based on the imaging signal is constant.

### TECHNICAL FIELD

The present invention relates to an imaging apparatus that is capable of changing the frame rate of an imaging signal.

Priority is claimed on Japanese Patent Application Publication No. 2007-90468, filed Mar. 30, 2007, the content of which is incorporated herein by reference.

### BACKGROUND ART

In conventional video production such as for television and movies, filming is performed that changes the number of frames that are imaged per second, that is, the frame rate, in order to impart a special effect to the video. For example, when imaging is performed by making the frame rate of the imaging signal faster than the frame rate of a playback signal, the video that is played back at the frame rate of the playback signal becomes a slow motion video. The faster the imaging frame rate becomes with respect to the playback frame rate, the playback video becomes a slower slow motion video, and the influence of the special effect becomes greater.

Conventionally, as methods of achieving an increase in the speed of the imaging frame rate, innovations have been made to shorten the signal read-out time from the imaging element by increasing the drive speed of the imaging element, or by dividing the signal to be read out from the imaging element into a plurality of channels and then reading them out simultaneously in order to speed up the imaging frame rate. However, increasing the drive speed of the imaging element or dividing the output channel into multiple lines causes degradation of image quality and leads to an increase of power consumption and circuit scale, so that there are many issues when actualizing the apparatus. Also, even if those innovations are implemented, in an imaging element with an increased number of pixels, when reading out the signals of all the pixels, the imaging frame rate does not increase dramatically.

Moreover, as another method of achieving an increase in the imaging frame rate, apparatuses have been proposed that are provided with a function to speed up the imaging frame rate by performing pixel decimation of the imaging element and reading out the signals, or reading out signals of only pixels in a partial region of the imaging element in order to reduce the number of output pixels. However, when performing pixel decimation of the imaging element and reading it out, a moire effect appears in the high frequency component of the photographic subject as a result of a change in the pixel pitch, and so quality of the image deteriorates. In order to remove the high-frequency component, the addition of a circuit that performs filter processing or processing called pixel addition is required.

An apparatus that achieves an increased speed of the imaging frame rate by reading signals from only pixels in a partial region of the imaging element is disclosed for example in Patent Document 1. Patent Document 1 discloses an apparatus provided with a high-resolution still picture mode and a low-resolution high frame rate moving picture mode. In the high-resolution still picture mode, the imaging of a still image is performed by reading signals from all the pixels of the imaging element, and in the low-resolution high frame rate moving picture mode, signals are read from only pixels of a partial region of the imaging element to make the imaging frame rate fast.

[Patent Document 1] Japanese Patent Application, First Publication No. 2003-158684

By reducing the size of the read-out region of the imaging element as in Patent Document 1, it is possible to make the imaging frame rate fast. However, in Patent Document 1, changing the size of the read-out region gives rise to the problem of the angle of field of the image based on the imaging signal changing.

The present invention was achieved in view of the above circumstances, and has as its object to provide an imaging apparatus that is capable of maintaining a constant angle of view even when changing the frame rate of the imaging signal.

### DISCLOSURE OF THE INVENTION

The imaging apparatus of the present invention was achieved in order to resolve the aforementioned issues, and is provided with an image-forming lens that images light from a photographic subject; an imaging part that accumulates a pixel signal that corresponds to an optical image formed by the image-forming lens, reads the pixel signal and outputs the pixel signal as an imaging signal; a lens magnification control part that controls a magnification of the image-forming lens; a read-out region control part that controls the size of a read-out region of the pixel signal; and a frame rate control part that controls a frame rate of the imaging signal. Moreover, in the imaging apparatus of the present invention, the magnification of the image-forming lens and the size of the read-out region are controlled so that an angle of view of an image based on the imaging signal is constant, and then the frame rate is controlled based on the amount of change in the size of the read-out region due to this control.

Also, in the imaging apparatus of the present invention, the read-out region control part may control the size of the read-out region based on the magnification of the image-forming lens so that the angle of view is constant.

Also, in the imaging apparatus of the present invention, the lens magnification control part may control the magnification of the image-forming lens based on the size of the read-out region so that the angle of view is constant.

Also, in the imaging apparatus of the present invention, the image-forming lens may have a zoom mechanism, and the read-out region control part may control the size of the read-out region in accordance with the zoom amount of the zoom mechanism.

Also, in the imaging apparatus of the present invention, the image-forming lens may have a variable power mechanism, and the read-out region control part may control the size of the read-out region in accordance with the magnification of the variable power mechanism.

Also, the imaging apparatus of the present invention may be further provided with a region detecting part that detects an image region that corresponds to a constant angle of view from a plurality of images that are generated by performing imaging while changing the magnification of the image-forming lens; and a storing part that stores in a corresponding manner the size of the read-out region and the magnification of the image-forming lens that correspond to the detected image region. The read-out region control part may control the size of the read-out region based on the correspondence relation between the size of the read-out region and the magnification of the image-forming lens that are stored in the storing part, and the magnification of the image-forming lens that is controlled by the lens magnification control part.

Also, the imaging apparatus of the present invention may be further provided with a region detecting part that detects an image region that corresponds to a constant angle of view from a plurality of images that are generated by performing imaging while changing the magnification of the image-forming lens; and a storing part that stores in a corresponding manner the size of the read-out region and the magnification of the image-forming lens that correspond to the detected image region. The lens magnification control part may control the magnification of the image-forming lens based on the correspondence relation between the size of the read-out region and the magnification of the image-forming lens that are stored in the storing part, and the size of the read-out region that is controlled by the read-out region control part.

### ADVANTAGEOUS EFFECTS OF THE INVENTION

According to the present invention, the magnification of the image-forming lens, the size of the read-out region, and the frame rate are controlled so that the angle of view of an image based on the imaging signal is constant. For that reason, it is possible to maintain a constant angle of view even when changing the frame rate of the imaging signal.

### BRIEF DESCRIPTION OF THE DRAWINGS

FIG. 1 is a block drawing that shows the constitution of an imaging apparatus in accordance with a first embodiment of the present invention.

FIG. 2 is a reference drawing that shows the appearance of the photographic angle of view in the first embodiment of the present invention.

FIG. 3 is a reference drawing that shows the appearance of the photographic angle of view in the first embodiment of the present invention.

FIG. 4 is a reference drawing that shows the correspondence relation of the magnification of the lens, the size of the read-out region of the imaging element, and the imaging frame rate in the first embodiment of the present invention.

FIG. 5 is a reference drawing that shows the correspondence relation of the magnification of the lens, the size of the read-out region of the imaging element, and the imaging frame rate in the first embodiment of the present invention.

FIG. 6 is a block drawing that shows the constitution of an imaging apparatus in accordance with a second embodiment of the present invention.

FIG. 7 is a reference drawing that shows the content of a table that correlates the magnification of the lens, the size of the read-out region of the imaging element, and the imaging frame rate in the second embodiment of the present invention.

FIG. 8A is a reference drawing for describing the method of creating the table in the second embodiment of the present invention.

FIG. 8B is a reference drawing for describing the method of creating the table in the second embodiment of the present invention.

### DESCRIPTION OF THE REFERENCE SYMBOLS

1 LENS
2 MAGNIFICATION SETTING PORTION
3 IMAGING ELEMENT
4 FRAME RATE SETTING PORTION
5 TABLE STORING PORTION
6 DRIVE CONTROL PORTION
7 SIGNAL PROCESSING PORTION
8 COMMUNICATION PORTION
9 IMAGE REGION DETECTING PORTION

### BEST MODE FOR CARRYING OUT THE INVENTION

Hereinbelow, embodiments of the present invention will be described with reference to the drawings.

### First Embodiment

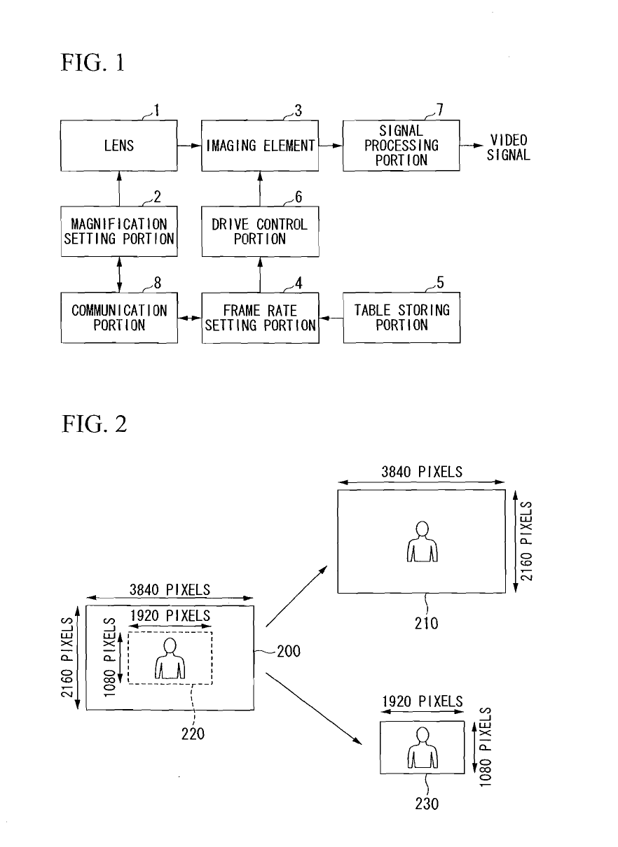

First, the first embodiment of the present invention will be described. FIG. 1 shows the constitution of the imaging apparatus in accordance with the present embodiment. In FIG. 1, a lens 1 (image-forming lens) is a lens provided with for example a zoom mechanism that includes a variable power optical system (not shown), and condenses light from a photographic subject (not shown) and forms an image. In addition to a zoom mechanism, one that has a variable power mechanism such as an extender or a converter may be applied to the lens 1. The image that is formed by the lens 1 enters an imaging element 3.

A magnification setting portion 2 controls imaging magnification by controlling the variable power optical system of the lens 1. The photographer can input the magnification of the lens 1 desired to be set into the magnification setting portion 2. The imaging element 3 (imaging part) is an XY address type solid-state imaging element that is capable of performing block reading. This imaging element 3 accumulates in each pixel a pixel signal obtained by a photoelectric conversion of the optical image that has entered the imaging element 3, reads this pixel signal, and outputs it as an imaging signal.

A frame rate setting portion 4 sets the frame rate of the imaging signal. Moreover, the frame rate setting portion 4 also performs setting of the size of the pixel signal read-out region of the imaging element 3 corresponding to the imaging frame rate that has been set. The photographer can input the imaging frame rate and the size of the read-out region of the imaging element 3 desired to be set into the frame rate setting portion 4. A table storing portion 5 (storing part) stores a table showing the correspondence relation between the magnification of the lens 1, the size of the read-out region of the imaging element 3, and the imaging frame rate.

A drive control portion 6 performs control of the drive timing, charge accumulation time, and the like of the imaging element 3, and in accordance with the imaging frame rate and the size of the read-out region of the imaging element 3 that were set by the frame rate setting portion 4, drives the imaging element 3 and causes it to output imaging signals of various frame rates. The frame rate of the imaging signal output from the imaging element 3 is changed such that the drive control portion 6 adjusts the period length of each frame by changing the cycle of the horizontal synchronizing signal and the vertical synchronizing signal in accordance with the size (pixel number) of the read-out region of the imaging element 3 set by the frame rate setting portion 4.

Moreover, by changing the time of each blanking (regression) period of the horizontal synchronizing signal and the vertical synchronizing signal, the drive control portion 6 may change the imaging frame rate without changing the size of the read-out region of the imaging element 3. For example, in the case of the read-out region of the imaging element 3 being 960 pixels in the horizontal direction and 540 pixels in the vertical direction, when each blanking period is made its shortest, the imaging frame rate is 384 frames per second, but when the blanking period is lengthened, it is possible to make the imaging frame rate slower than 384 frames per second with the read-out region remaining 960 pixels in the horizontal direction and 540 pixels in the vertical direction.

A signal processing portion 7 performs signal processing such as noise removal and signal level amplification for improving the image on the imaging signal output from the imaging element 3, and outputs it as a video signal. A communication portion 8 communicates information mutually between the magnification setting portion 2 and the frame rate setting portion 4. For example, the communication portion 8 transmits information of the magnification of the lens 1, which has been set by the magnification setting portion 2, to the frame rate setting portion 4, or transmits information of the magnification of the lens 1, which has been read from the table storing portion 5 by the frame rate setting portion 4, to the magnification setting portion 2.

The magnification setting portion 2 and the frame rate setting portion 4 serve as a lens magnification control part of the present invention. Moreover, the frame rate setting portion 4 and the drive control section 6 serve as a read-out region control part and a frame rate control part of the present invention.

Next, the relationship of the read-out region and the photographic angle of view of the imaging element 3 will be explained. FIG. 2 shows the appearance of the photographic angle of view at the time of changing the size of the read-out region of the imaging element 3 with the magnification of the lens 1 fixed. For example, it is assumed that an effective pixel region 200 of the imaging element 3 consists of 3,840 pixels in the horizontal direction and 2,160 pixels in the vertical direction. When the read-out region of the imaging element 3 is set to all pixels, an image 210 is generated based on the pixel signals read from the entirety of the effective pixel region 200. Also, when the read-out region of the imaging element 3 is set to one-half of the effective pixel region 200 in both horizontal and vertical directions, a read-out region 220 becomes a region constituted by 1,920 pixels in the horizontal direction and 1,080 pixels in the vertical direction, and so an image 230 one-fourth the size of the image 210 is generated.

At this time, even if the size of the read-out region of the imaging element 3 changes, the central pixel of the read-out region shall always be fixed at the central pixel of the imaging element 3. As is evident from the images 210 and 230, the photographic angle of view when the read-out region of the imaging element 3 is set to one-fourth becomes in both horizontal and vertical directions one-half the photographic angle of view when the read-out region of the imaging element 3 is set to all pixels. By changing the size of the read-out region of the imaging element 3 in this manner, it is possible to change the photographic angle of view.

Also, it is possible to change the read-out region of the imaging element 3 to be smaller as desired, and by reducing the number of pixels that are read, it is possible to make the imaging frame rate faster (higher). For example, in the case of the drive frequency of the imaging element 3 being 200 MHz and the number of read-out pixels of the imaging element being 3,840 in the horizontal direction and 2,160 pixels in the vertical direction, the imaging frame rate become 24 frames per second. Moreover, when the number of read-out pixels of the imaging element 3 is 1,920 pixels in the horizontal direction and 1,080 pixels in the vertical direction, the imaging frame rate becomes 96 frames per second. Furthermore, when the number of read-out pixels of the imaging element 3 is 960 pixels in the horizontal direction and 540 pixels in the vertical direction, the imaging frame rate becomes 384 frames per second.

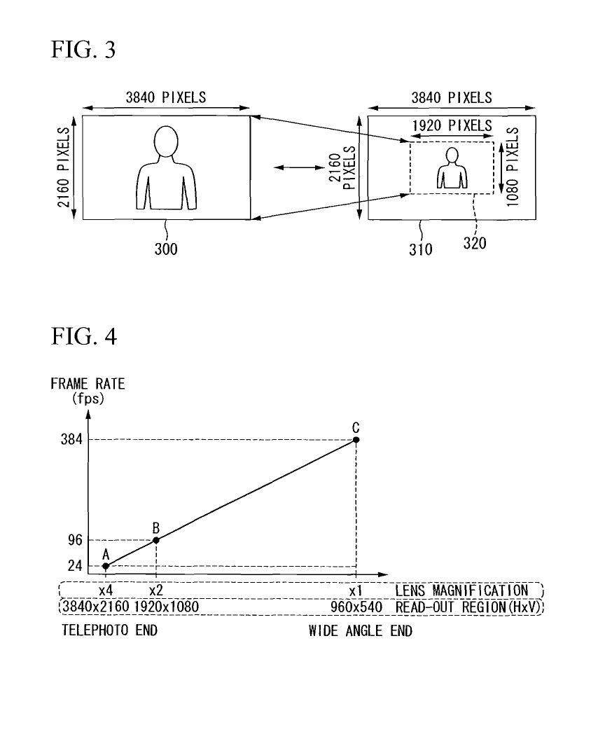

Next, the relationship between the magnification and the photographic angle of view of the lens 1 will be described. FIG. 3 shows the appearance of the photographic angle of view in the case of changing the magnification of the lens 1 in the state of imaging a photographic subject with the read-out region of the imaging element 3 set to all pixels. When imaging a photographic subject in a state where the read-out region of the imaging element 3 is the same as the effective pixel region, an image 300 is generated. When the magnification of the lens 1 is set to one-half in this state, the photographic angle of view doubles in both the horizontal and vertical directions, and an image 310 is generated. A dashed line 320 shows the photographic angle of view after the change in magnification that is equal to the photographic angle of view prior to changing the magnification of the lens 1. Assuming the positional relationship of the photographic subject and the imaging apparatus does not change, the region enclosed by the dashed line 320 will be equal to a region constituted by 1,920 pixels in the horizontal direction and 1,080 pixels in the vertical direction, that is, a region that is one-fourth of the effective pixel region.

From the aforementioned, when the state of having changed the magnification of the lens 1 by one-half power to the wide angle side and having changed the read-out region of the imaging element to one-fourth is compared with the state prior to changing the magnification of the lens 1 and the read-out region of the imaging element 3, the proportion of the photographic subject size to the photographic angle of view is the same, that is, the photographic angle of view with respect to the size of the photographic subject is the same. Moreover, when the read-out region of the imaging element 3 is set to one-fourth of all the pixels, it becomes possible to perform imaging with an imaging frame rate that is four times as fast as the imaging frame rate when the read-out region set to all pixels. Accordingly, by setting the size of the read-out region of the imaging element 3 so that the photographic angle of view may become constant in correspondence with the magnification of the lens 1, it becomes possible to perform imaging with a changed imaging frame rate.

Next, the method of setting the magnification of the lens 1, the size of the read-out region of the imaging element 3, and the imaging frame rate in the present embodiment will be described. Hereinbelow, although the case of the zoom factor of the lens 1 set to 4 times will be described, the zoom factor of the lens 1 may be other than 4 times. FIG. 4 shows the imaging frame rate that can be set in the imaging apparatus when the magnification (lens magnification) of the lens 1 and the read-out region are respectively changed so that the photographic angle of view with respect to the size of the photographic subject does not change.

The horizontal axis of FIG. 4 expresses the lens magnification and the size of the read-out region, and the vertical axis expresses the imaging frame rate. Point A in the drawing indicates that the lens magnification is 4× and furthest to the telephoto side, and that the read-out region of the imaging element 3 is set to all pixels of 3,840 pixels in the horizontal direction and 2,160 pixels in the vertical direction. The imaging frame rate at this time is 24 frames per second. Point B indicates that the lens magnification is set to 2× as a result of moving by ½ power from the telephoto end to the wide angle side, and the read-out region of the imaging element 3 is set to one-fourth of the whole at 1,920 pixels in the horizontal direction and 1,080 pixels in the vertical direction. The imaging frame rate at this time is 96 frames per second, which is four times the imaging frame rate at point A. Point C indicates that the lens magnification is set to the wide angle end of 1× as a result of moving by ¼ power from the telephoto end to the wide angle side, and the read-out region of the imaging element 3 is set to 1/16 of the whole at 960 pixels in the horizontal direction and 540 pixels in the vertical direction. The imaging frame rate at this time is 384 frames per second, which is 16 times the imaging frame rate at point A.

A table showing the aforementioned correspondence relation of the magnification of the lens 1, the size of the read-out region of the imaging element 3, and the imaging frame rate is housed in the table storing portion 5. In the case of the magnification setting portion 2 changing the magnification of the lens 1 with instructions of the photographer, the information is sent to the frame rate setting portion 4 via the communication portion 8. From the table housed in the table storing portion 5, the frame rate setting portion 4 reads the size of the read-out region of the imaging element 3 and the imaging frame rate corresponding to the changed magnification of the lens 1, and sets those values to the drive control portion 6. The drive control portion 6 drives the imaging element 3 based on those set values. Thereby, in accordance with a change of the magnification of the lens 1, it becomes possible to change the size of the read-out region and the imaging frame rate without changing the photographic angle of view.

A photographer is also able to perform filming by specifying the desired size of the read-out region (that is, the number of imaging pixels) and the imaging frame rate. When a photographer has input the size of the read-out region of the imaging element 3 into the frame rate setting portion 4, the frame rate setting portion 4 reads the magnification of the lens 1 and the imaging frame rate that correspond to the input size of the read-out region of the imaging element 3 from the table that is stored in the table storing portion 5, and sets those values to the drive control section 6. The drive control section 6 drives the imaging element 3 based on those set values. Moreover, the information on the magnification of the lens 1 that the frame rate setting portion 4 has read from the table is sent to the magnification setting portion 2 via the communication portion 8. The magnification setting portion 2 sets the magnification of the lens 1 based on that information.

Also, when a photographer has input an imaging frame rate into the frame rate setting portion 4, the frame rate setting portion 4 reads the magnification of the lens 1 and the size of the read-out region of the imaging element 3 that correspond to the input imaging frame rate from the table that is stored in the table storing portion 5, and sets those values to the drive control section 6. The drive control section 6 drives the imaging element 3 based on those set values. At this time, the drive control section 6 controls the imaging element 3 so that a signal is read out from the largest read-out region that realizes the set imaging frame rate, that is, so that the imaging element 3 is driven at synchronizing signals in which the horizontal and vertical blanking periods are shortest. Moreover, the information on the magnification of the lens 1, which has been read from the table by the frame rate setting portion 4, is sent to the magnification setting portion 2 via the communication portion 8. The magnification setting portion 2 sets the magnification of the lens 1 based on that information.

FIG. 5 shows the imaging frame rate in the case of varying the blanking period of each synchronizing signal that is read while fixing the read-out region of the imaging element 3 at point A, point B, and point C of FIG. 4. The slowest imaging frame rate of the imaging element 3 is 1 frame per second, and it is possible to select an imaging frame rate in the range of 1 to 24 frames per second at point A, 24 to 96 frames at point B, and 96 to 384 frames per second at point C.

When the change to the magnification of the lens 1 is decided beforehand, filming may be performed by independently controlling the imaging frame rate in accordance with the size of the read-out region that is set, using the table of content shown in FIG. 5. When the magnification of the lens 1 is fixed, it is possible to control the imaging frame rate with the resolution in accordance with the size of the read-out region made constant.

As described above, according to the present embodiment, the magnification of the lens 1, the size of the read-out region of the imaging element 3, and the imaging frame rate are controlled so that the photographic angle of view is constant. For this reason, even if the imaging frame rate is changed, it is possible to maintain a constant photographic angle of view.

### Second Embodiment

Next, the second embodiment of the present invention will be described. Although it is possible to apply the imaging apparatus in accordance with the first embodiment to an apparatus with interchangeable lenses, since there are effects due to individual differences of lenses such as magnification accuracy and image curvature due to aberration, even if the magnification of the lens 1 and the size of the read-out region are independently set so that the photographic angle of view is actually constant with respect to the size of the photographic subject, the size of the read-out region does not necessarily change in a linear manner corresponding to a linear change in the magnification of the lens 1. Therefore, in an imaging apparatus in accordance with the present embodiment, by recording the magnification of the lens 1 that includes the individual difference of the lens 1 and the size of the read-out region that corresponds thereto, even when various lenses are used, it is possible to make the photographic angle of view constant with respect to the size of the photographic subject.

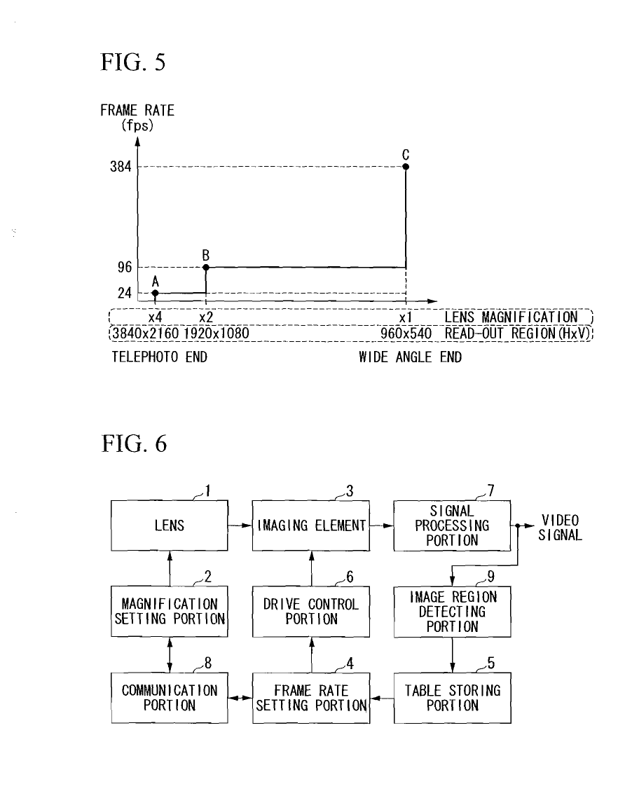

FIG. 6 shows the constitution of the imaging apparatus in accordance with the present embodiment. In the present embodiment, an image region detecting portion 9 is provided. The image region detecting portion 9 (region detecting part) detects the image region that satisfies a predetermined condition from the image based on the imaging signal (video signal) processed by the signal processing portion 7. Also, the table of content shown in FIG. 7 is stored in the table storing portion 5 of the present embodiment. This table correlates the magnification of the lens 1 (lens magnification) and the size of the read-out region of the imaging element 3 that realize a constant photographic angle of view. Also, the individual difference of the lens 1 is reflected in this table, and it is created in advance in the following manner.

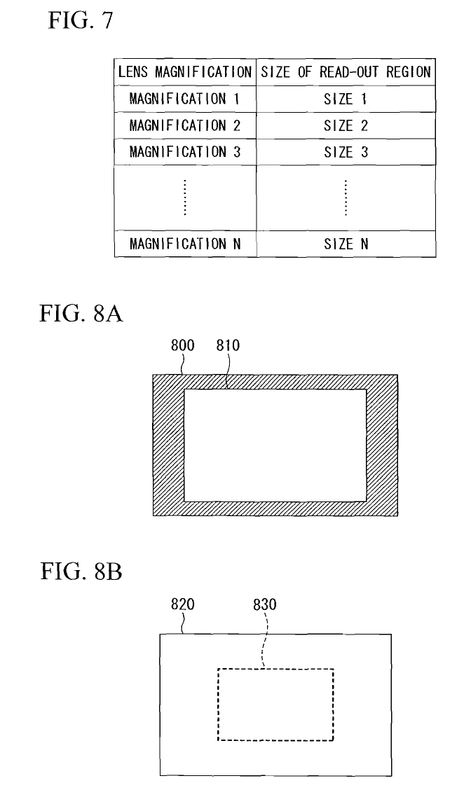

First, as shown in FIG. 8A, a test chart 800 is prepared in which the periphery is black and the center is white with little unevenness with a size that is equal to the aspect ratio of the imaging element 3. Then, the test chart 800 is arranged so that a white region 810 of the test chart 800 occupies the entire angle of view when filming in a state of the magnification of the lens 1 being at the telephoto end, and filming of the test chart 800 is performed multiple times while changing the magnification of the lens 1 from the telephoto end to the wide angle end. At this time, the read-out region of the imaging element 3 is set to all pixels.

The region 810 of the test chart 800 in the photographic image changes according to the change of the magnification of the lens 1, as shown in FIG. 8B. That is, in the case of performing filming in a state of the magnification of the lens 1 being at the telephoto end, a region in which the region 810 of the test chart 800 forms an image is the same as an effective pixel region 820 of the imaging element 3. Also, in the case of performing filming in a state of the magnification of the lens 1 being at the wide angle end, the region of the region 810 of the test chart 800 that forms an image becomes a region 830.

The region 810 of the test chart 800 can be detected as a region that consists of pixels in which the brightness level of each pixel is equal to or greater than a predetermined threshold value. From each image generated by the multiple filmings, the image region detecting portion 9 detects the region 810 of the test chart 800, matches the size thereof and the magnification of the lens 1 when each image was filmed, and stores them in the table storing portion 5. The table of the content shown in FIG. 7 is created in this way. The operation of the imaging apparatus using this table is the same as in the first embodiment.

As mentioned above, according to the present embodiment, it is possible to maintain a constant photographic angle of view regardless of the individual difference of the lens 1.

Preferred embodiments of the present invention have been described in detail above with reference to the drawings, but specific constitutions are not necessarily limited to the abovementioned embodiments, and design modifications in a range that do not depart from the spirit of the present invention are also included. For example, the magnification of the lens 1 that is transmitted between the magnification setting portion 2 and the frame rate setting portion 4 via the communication portion 8, or the magnification of the lens 1 that is stored in the table storing portion 5 may be the zoom amount of the zoom mechanism that is provided in the lens 1. Alternatively, in the case of the lens 1 having a variable power mechanism such as an extender or a converter, it the magnification thereof may be used. Also, instead of the test chart 800 of FIG. 8A, one that applies a mask of a size with the same aspect ratio as the imaging element 3 to a light source with little unevenness such as a viewer may be used.

### INDUSTRIAL APPLICABILITY

According to the present invention, it is possible to provide an imaging apparatus that is capable of maintaining a constant angle of view even in the case of changing the frame rate of an imaging signal.

1. An imaging apparatus comprising:
an image-forming lens that images light from a photographic subject;
an imaging part that accumulates a pixel signal that corresponds to an optical image formed by the image-forming lens, reads the pixel signal and outputs the pixel signal as an imaging signal;
a lens magnification control part that controls a magnification of the image-forming lens;
a read-out region control part that controls the size of a read-out region of the pixel signal; and
a frame rate control part that controls a frame rate of the imaging signal,
wherein the magnification of the image-forming lens and the size of the read-out region are controlled so that an angle of view of an image based on the imaging signal is constant, and then the frame rate is controlled based on the amount of change in the size of the read-out region due to this control.

2. The imaging apparatus according to claim 1, wherein the read-out region control part controls the size of the read-out region based on the magnification of the image-forming lens so that the angle of view is constant.

3. The imaging apparatus according to claim 1, wherein the lens magnification control part controls the magnification of the image-forming lens based on the size of the read-out region so that the angle of view is constant.

4. The imaging apparatus according to claim 2, wherein the image-forming lens has a zoom mechanism, and the read-out region control part controls the size of the read-out region in accordance with the zoom amount of the zoom mechanism.

5. The imaging apparatus according to claim 2, wherein the image-forming lens has a variable power mechanism, and the read-out region control part controls the size of the read-out region in accordance with the magnification of the variable power mechanism.

6. The imaging apparatus according to claim 1, further comprising:
a region detecting part that detects an image region that corresponds to a constant angle of view from a plurality of images that are generated by performing imaging while changing the magnification of the image-forming lens; and
a storing part that stores in a corresponding manner the size of the read-out region and the magnification of the image-forming lens that correspond to the detected image region,
wherein the read-out region control part controls the size of the read-out region based on the correspondence relation between the size of the read-out region and the magnification of the image-forming lens that are stored in the storing part, and the magnification of the image-forming lens that is controlled by the lens magnification control part.

7. The imaging apparatus according to claim 1, further comprising:
a region detecting part that detects an image region that corresponds to a constant angle of view from a plurality of images that are generated by performing imaging while changing the magnification of the image-forming lens; and
a storing part that stores in a corresponding manner the size of the read-out region and the magnification of the image-forming lens that correspond to the detected image region,
wherein the lens magnification control part controls the magnification of the image-forming lens based on the correspondence relation between the size of the read-out region and the magnification of the image-forming lens that are stored in the storing part, and the size of the read-out region that is controlled by the read-out region control part.
